(19) United States
(12) Patent Application Publication
(10) Pub. No.: US 2011/0072145 A1
(43) Pub. Date: Mar. 24, 2011

(54) NETWORK DEVICE PERFORMING CONNECTION CHECK, NETWORK SYSTEM, AND FRAME TRANSFER METHOD

(75) Inventors: Junichi Takeuchi, Kanagawa (JP); Naoto Iga, Kanagawa (JP); Hideki Goto, Aichi-ken (JP); Shinichi Iiyama, Tokyo (JP)

(73) Assignees: RENESAS ELECTRONICS CORPORATION, KANAGAWA (JP); TOYOTA JIDOSHA KABUSHIKI KAISHA., TOYOTA-SHI (JP)

(21) Appl. No.: 12/934,544

(22) PCT Filed: Mar. 26, 2009
(86) PCT No.: PCT/IB09/05439

§ 371 Date: Dec. 6, 2010

(30) Foreign Application Priority Data
Mar. 26, 2008 (JP) 2008-080668

(51) Int. Cl. G06F 15/16

(52) U.S. Cl. 709/230

(57) ABSTRACT

A network device that transfers frames by repeating, in a constant cycle, a reserved transfer interval that is a time band, in which a frame is transferred with a reservation, and a free transfer interval that is a time band, in which a frame is freely transferred, includes: a BPDU generation unit that generates a first BPDU; and a BPDU transmission instruction unit that instructs to arrange the first BPDU in the reserved transfer interval and transmit the first BPDU to a first other network device.

### BACKGROUND OF THE INVENTION

1. Field of the Invention

This invention relates to a network device performing a connection check, a network system, and a frame transfer method.

2. Description of the Related Art

Real-time communication technology such as Institute of Electrical and Electronic Engineers (IEEE) 1394 employs a transfer system using a cycle including real time data and best effort data (referred to hereinbelow as “cyclic transfer”). FIG. 6 shows a standard cycle pattern. As shown in FIG. 6, cycles are repeated by taking predetermined 125 μs as one cycle. Packet data, that is, a frame, occupying a predetermined band within this one cycle is transferred between network devices. Here, the first half of one cycle is taken as a reserved transfer interval and the second half is taken as a free transfer interval.

The reserved transfer interval is used for real time data communication. In the reserved transfer interval, for example, as shown in FIG. 6, a predetermined time, that is, bands 1 to 5 are reserved for frame transmission. Each of the reserved bands 1 to 5 is used only between set devices. Where frames A1 to A5 of real time data are arranged in the reserved bands 1 to 5, a constant amount of data communication is possible within a constant time. A synchronization frame for synchronizing the network devices is disposed in the header of the reserved transfer interval (not shown in the figure).

By contrast, the free transfer interval is used for best effort data communication that has no real time property. In this interval, no band is reserved. For example, as shown in FIG. 6, when a band 6 of this interval is free during data transfer, a frame B1 is arranged therein and data communication between the devices is performed. Frames B2 to B5 are similarly arranged in respective bands.

For example, a daisy-chain connection composed of network devices 11 to 14 shown in FIG. 7 and a star connection composed of network devices 11, 12, 13, and 15 can be considered as a network configuration that realizes a cyclic transfer. Each network device has a bridge function, and network devices 12, 13, and 15 can transfer a frame transmitted from a network device on one side of the device to a network device on the other side. As a result, communication can be performed by using a bridge function even between the network devices that are not directly connected to each other.

There is a trend to applying the above-described cyclic transfer to Ethernet (registered trademark), which is a Local Area Network (LAN) standard, and high speed and high reliability of data communication with the cyclic transfer are sought for a LAN using the Ethernet (registered trademark).

A Spanning Tree Protocol (STP) specified in IEEE 802.1d and a Rapid Spanning Tree Protocol (RSTP) specified in IEEE 802.1w are available as network management protocols that take into account the recovery from a network failure.

FIG. 8 shows a schematic diagram of a typical network employing the RSTP. As shown in FIG. 8, in a network configured by network devices A to E, a frame called a Bridge Protocol Data Unit (BPDU) is periodically transmitted from network device A that is a root (also called “a master”) (see for example, Japanese Patent Application Publication No. 2006-13621 (JP-A-2006-13621)). The connection of all the network devices constituting the network can be checked with the BPDU.

When a failure occurs in a certain ground point of a network, no BPDU arrives therefrom to the destination. Accordingly, a general restoration operation from a failure is started according to a flowchart shown in FIG. 9. More specifically, for example, when a line disconnection occurs between network device C and network device D, the BPDU does not reach network device D (see FIG. 8). As a result, network disconnection is detected (S1). Network device D then starts a handshake with network device B via a redundant path on the root side shown by a broken line in FIG. 8 (S2). Network device B and network device D are physically connected, but the connection therebetween was blocked in order to avoid an endless loop of a frame. In response to a request from network device D, network device B activates the network connection between the two network devices. Thus, a new topology is created in the network. A frame indicating the topology change is sent from network device D and transmitted to all the devices (S3).

Usually one BPDU is transmitted every 2 seconds. However, when the amount of data in the network is large, there is a risk of the BPDU transfer being delayed. The resultant problem is that the failure recovery is delayed.

### SUMMARY OF THE INVENTION

The present invention provides a network device performing a connection check, a network system, and a frame transfer method capable of restoring the network rapidly from a failure, regardless of the amount of data in the network.

The first aspect of the invention relates to a network device that transfers frames by repeating, in a constant cycle, a reserved transfer interval that is a time band, in which a frame is transferred with a reservation, and a free transfer interval that is a time band, in which a frame is freely transferred. The network device has a BPDU generation unit that generates a first BPDU and a BPDU transmission instruction unit that instructs to arrange the first BPDU in the reserved transfer interval and transmit the first. BPDU to a first other network device.

In the above-described aspect, a synchronization frame for synchronizing network devices within a network may be arranged in a header of the reserved transfer interval, and the first BPDU may be arranged to follow the synchronization frame.

In the above-described aspect, the network device may further include a BPDU reception unit that receives a second BPDU transmitted from a second other network device. The BPDU generation unit may generate the first BPDU on the basis of the second BPDU.

In the above-described aspect, the BPDU reception unit may receive a third BPDU transmitted from the first other network device. The BPDU generation unit may generate a fourth BPDU on the basis of the third BPDU. The BPDU transmission instruction unit may arrange the fourth BPDU in the reserved transfer interval and transmit the fourth BPDU to the second other network device.

In the above-described aspect, an interval in which a frame transfer is prohibited may be provided at an end of the free transfer interval.

In the above-described aspect, a frame gap may be provided at least in one of before and after each of the BPDU.

In the above-described aspect, a system of communication between the first and second other network devices may be a full duplex system.

In the above-described aspect, one of the first other network device and the second other network device may receive a fifth BPDU transmitted from a third other network device connected to one of the first other network device and the second other network device. The third other network device may not be directly connected to the network device. When the third other network device and one of the first other network device and the second other network device are disconnected, one of the first other network device and the second other network device may notify the network device about the disconnection.

In the above-described aspect, when the connection between the network device and one of the first other network device and the second other network device is disconnected and a redundant path exists between the one of the other network device that has been disconnected and the network device or the other one of the other network device, the one of the other network device may activate the redundant path. The one of the other network device may transmit a fifth BPDU to the network device or the other one of the other network device connected by the redundant path.

The second aspect of the invention relates to a network system including a network device that transfers frames by repeating, in a constant cycle, a reserved transfer interval that is a time band, in which a frame is transferred with a reservation, and a free transfer interval that is a time band, in which a frame is freely transferred. The network device generates a first BPDU, arranges the first BPDU in the reserved transfer interval, and transmits the first BPDU to a first other network device.

In the above-described aspect, a synchronization frame for synchronizing network devices within a network may be arranged in a header of the reserved transfer interval and the first BPDU may be arranged to follow the synchronization frame.

In the above-described aspect, the network device further has a BPDU reception unit that receives a second BPDU transmitted from a second other network device. The BPDU generation unit generates the first BPDU on the basis of the second BPDU.

In the above-described aspect, the network device may receive a third BPDU transmitted from the first other network device, generate a fourth BPDU on the basis of the third BPDU, arrange the fourth BPDU in the reserved transfer interval, and transmit the fourth BPDU to the second other network device.

In the above-described aspect, an interval in which a frame transfer is prohibited may be provided at an end of the free transfer interval.

In the above-described aspect, a frame gap may be provided at least in one of before and after each of the BPDU.

In the above-described aspect, a system of communication between the first and second other network devices may be a full duplex system.

In the above-described aspect, the network system may further include a third other network device connected to one of the first other network device and the second other network device. The third other network device may not be directly connected to the network device. When the third other network device and one of the first other network device and the second other network device are disconnected, one of the first other network device and the second other network device may notify the network device about the disconnection.

In the above-described aspect, when the connection between the network device and either of the first other network device and the second other network device is disconnected and a redundant path exists between the one of the other network device that has been disconnected and the network device or the other one of the other network device, the one of the other network device may activate the redundant path. The one of the other network device may transmit a fifth BPDU to the network device or the other one of the other network device connected by the redundant path.

The third aspect of the invention relates to a frame transfer method by which frames are transferred between network devices by repeating, in a constant cycle, a reserved transfer interval that is a time band in which a frame is transferred with a reservation and a free transfer interval that is a time band in which a frame is freely transferred. A first network device generates a first BPDU, arranges the first BPDU in the reserved transfer interval, and transmits the first BPDU to a second network device.

In the above-described aspect, the first network device may arrange a synchronization frame for synchronizing network devices within a network in a header of the reserved transfer interval and arrange the first BPDU to follow the synchronization frame.

In the above-described aspect, the first network device may receive a second BPDU transmitted from a third network device and generate the first BPDU on the basis of the second BPDU.

In the above-described aspect, the first network device may receive a third BPDU transmitted from the second network device, generate a fourth BPDU on the basis of the third BPDU, arrange the fourth BPDU in the reserved transfer interval, and transmit the fourth BPDU to the third network device.

In the above-described aspect, an interval in which frame transfer is prohibited may be provided at an end of the free transfer interval.

In the above-described aspect, a system of communication between the first network device and the second and third network devices may be a full duplex system.

By using the network device, network system, or frame transfer method in accordance with the invention, it is possible to restore the network rapidly from a failure, regardless of the amount of data in the network.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a schematic diagram of a network of the embodiment;

FIG. 2 is a block diagram of a network device of the embodiment;

FIG. 3 illustrates a frame transfer cycle of the network device of the embodiment;

FIG. 4 is a schematic diagram of BPDU transfer in the network of the embodiment;

FIG. 5 is a flowchart of a recovery operation from a failure of the network of the embodiment;

FIG. 6 shows an example of a frame transfer cycle;

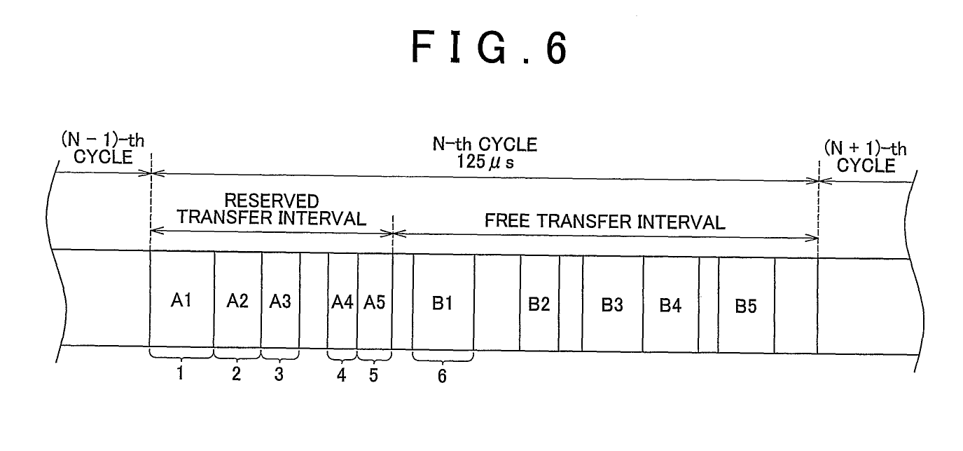

FIG. 7 is a schematic diagram of a network;

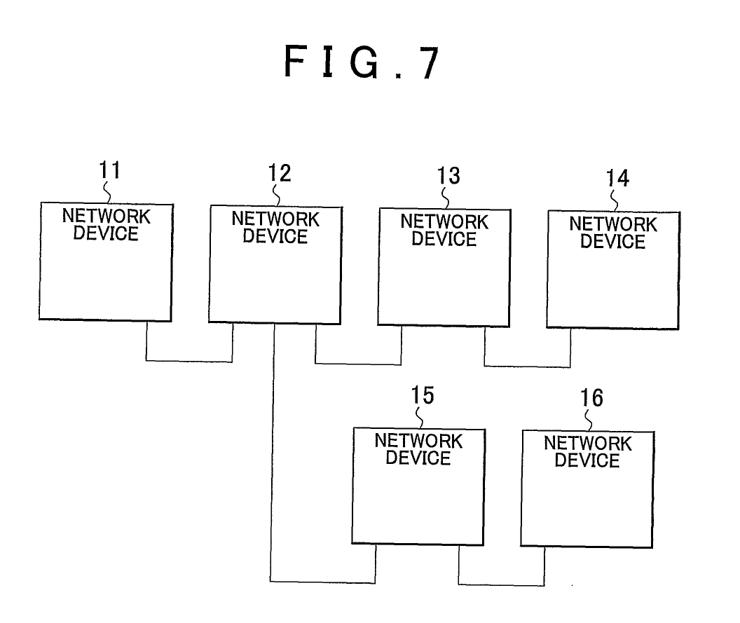

FIG. 8 is a schematic diagram of BPDU transfer in a typical network; and

FIG. 9 is a flowchart illustrating a recovery operation from a typical failure of a network.

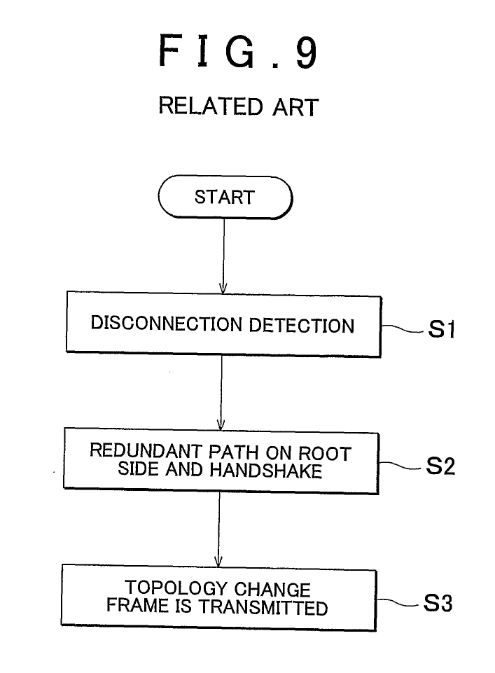

### DETAILED DESCRIPTION OF AN EMBODIMENT

A specific embodiment employing the invention will be described below in greater detail with reference to the appended drawings. However, the invention is not limited to the below-described embodiment. Furthermore, the description and drawings below are appropriately simplified to clarify the explanation.

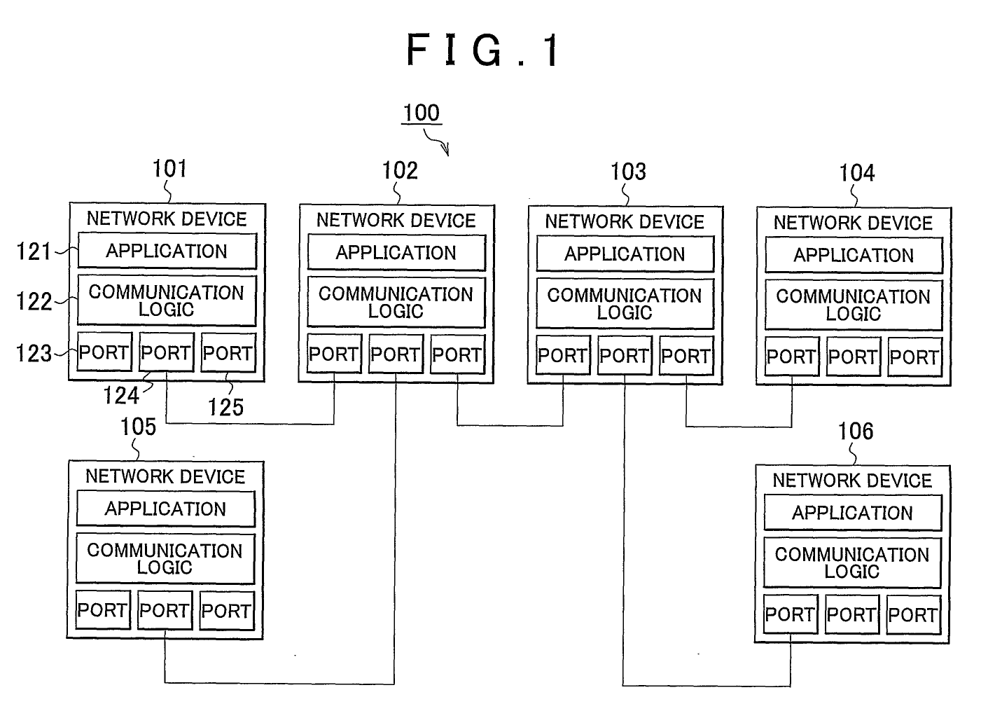

FIG. 1 shows a general network configuration and a network device of the embodiment. As shown in FIG. 1, a network 100 has network devices 101 to 106. The network devices 101 to 106 perform transmission and reception of frames by cyclic transfer. Because the network devices 101 to 106 have identical configuration, the network device 101 will be explained herein by way of example. The network device 101 has an application 121, a communication logic 122, and ports 123 to 125.

The application 121 generates data to be used in another network device in the network or uses data generated in another network device. Examples of the application include generation of video data by using a peripheral device such as a camera and transmission of the video data to another network device and display of video data transmitted by another network device on a display.

The communication logic 122 is configured, for example, by a Media Access Control (MAC) bridge (including a switch, a rooting table, etc. for realizing bridge communication between a plurality of ports in the device itself) specified by IEEE 802.1 or a circuit performing operation and control specified by a protocol such as STP and RSTP. Furthermore, the communication logic 122 also performs control of dividing data generated by the application 121 to a predetermined length and adding control information to obtain a frame.

The ports 123 to 125 perform transmission and reception of frames between network devices. For example, a connector or a cable specified by IEEE 802.3 and hardware conforming to a transmission-reception protocol such as MAC can be used as the ports 123 to 125.

The communication logic 122 and application 121 a connected to adjacent network devices via the ports 123 to 125, thereby configuring the network 100. The connection between the network devices may be a daisy-chain connection composed of network devices 101 to 104 or a star connection composed of network devices 101, 102, 103, and 105.

In each network device, a rooting table (not shown in the figure) located in the own device saves information indicating which port of the own device is connected to which port of another network device. As a result, even when a plurality of ports are used, as in the network device 102 or 103, each network device performs communication between the ports of the adequate network device on the basis of this information.

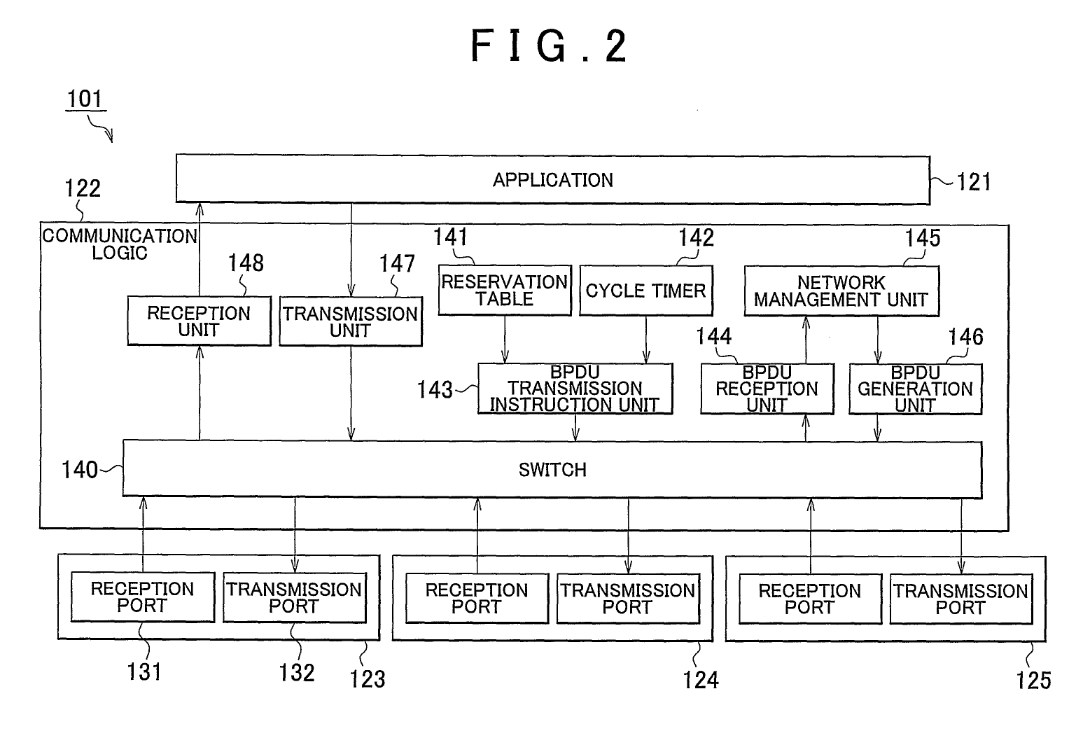

FIG. 2 shows in greater detail a configuration block diagram of the network devices 101 to 106 shown in FIG. 1. Because the network devices 101 to 106 have identical configuration, the network device 101 will be explained hereinbelow by way of example. In FIG. 2 components denoted by the same reference numerals as in FIG. 1 have similar configuration and explanation thereof is herein omitted.

Each port from among the ports 123 to 125 has a respective reception port and a transmission port. The reception port sends a frame that arrived from another network device to a below-described switch 140. The transmission port transmits a frame sent from the switch 140 to another network device.

The communication logic 122 has a switch 140, a reservation table 141, a cycle timer 142, a BPDU transmission instruction unit 143, a BPDU reception unit 144, a network management unit 145, a BPDU generation unit 146, a transmission unit 147, and a reception unit 148.

The switch 140 performs bridge communication between a plurality of ports in the own device, for example, between the reception port of the port 123 and the transmission port of the port 125. Furthermore, the switch 140 sends a frame received by the own device to the reception unit 148 and sends a frame sent from the transmission unit 147 to the transmission port 132 of the designated port. Here, when the data received from the switch 140 are the own device address, the reception unit 148 sends the received data to the adequate application 121. The transmission unit 147 sends the data received from the application 121 to the switch 140. Furthermore, the switch 140 sends the BPDU received from the other network device to the BPDU reception unit 144.

The reservation table 141 sends information indicating which time band has already been reserved to the BPDU transmission instruction unit 143. The cycle timer 142 measures the time information of the own device and sends this time information to the BPDU transmission instruction unit 143. Here, because all the network devices in the network are synchronized, the cycle timers 142 of all the network devices show the same time. A method based on IEEE 1588 is available as a method for synchronizing the network devices. Detailed explanation of IEEE 1588 is herein omitted. The BPDU transmission instruction unit 143 generates a BPDU transmission instruction signal on the basis of information from the reservation table 141 and cycle timer 142.

The BPDU reception unit 144 sends the BPDU received from the other network device to the network management unit 145. The network management unit 145 instructs the BPDU generation unit 146 to change the received BPDU correspondingly to the status of the own device and the like. The BPDU generation unit 146 generates a BPDU on the basis of instruction from the network management unit 145. The BPDU generated by the BPDU generation unit 146 is sent to the transmission port 132 connected to the transmission destination by the switch 140 on the basis of the BPDU transmission instruction signal from the BPDU transmission instruction unit 143. The BPDU is then transferred. Within the interval from the BPDU transmission instruction to the BPDU transmission completion, the network device 101 preferentially transmits the BPDU.

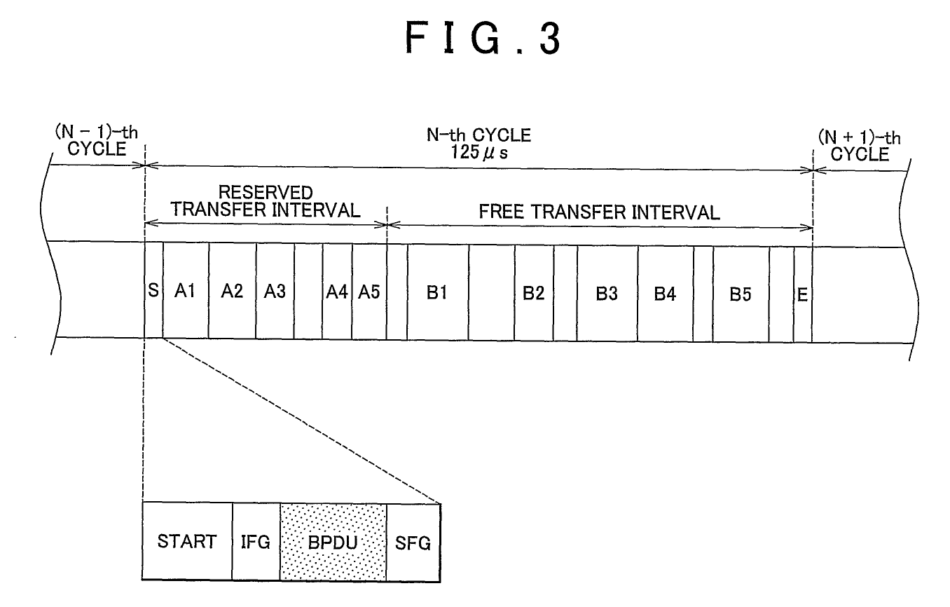

A frame transfer cycle will be explained below. FIG. 3 shows a cycle pattern of frame transfer in the network device in accordance with the invention. As shown in FIG. 3, a predetermined interval of 125 μs is taken as 1 cycle, and the cycle is repeated. In this case, the first half of one cycle is set as a reserved transfer interval and the second half is set as a free transfer interval.

The reserved transfer interval is used for real time data communication. In the reserved transfer interval, for example, as shown in FIG. 3, a predetermined time, that is, bands 1 to 5 are reserved for frame transmission. Each of the reserved bands 1 to 5 is used only between set devices. Where frames A1 to A5 of the real time data are arranged in the reserved bands 1 to 5, data communication of a fixed amount becomes possible within a fixed interval.

As shown in FIG. 3, a start interval S is provided in the header of each cycle, that is, in the header of a reserved transfer interval of each cycle. As shown in an enlarged form in FIG. 3, a synchronization frame START for synchronizing network devices is arranged in the header of the start interval S. A BPDU is arranged via an Inter-Frame Gap (IFG) after the synchronization frame START. A Start Frame Gap (SFG) is provided at the rear end of the BPDU to prevent competition with other adjacent reserved frame.

The BPDU is thus arranged and transferred in the reserved transfer interval of each cycle. As a result, the BPDU can be reliably transferred in each cycle. Therefore, a failure can be instantaneously detected and recovery from the failure can be accelerated. A BPDU may be arranged based on the received information of the synchronization frame START, rather than the information from the cycle timer 142.

By contrast, the free transfer interval is used for communication of best effort data that do not have a real time property. In the free transfer interval, no band is reserved. For example, when a band 6 of this interval is vacant during data transfer, as shown in FIG. 3, the frame B1 is arranged therein and data communication between the devices is performed. Likewise, the frames B2 to B5 are also arranged in respective bands.

As shown in FIG. 3, a cycle end interval E is provided in the final section of the free transfer interval. The cycle end interval E is a transfer prohibition interval. Thus, the competition of the frame positioned in the final section of the free transfer interval and the synchronization frame START and BPDU positioned in the header of the next cycle is prevented. As a result, the synchronization frame START and BPDU can be transferred more reliably in each cycle. Therefore, a failure can be detected even faster and the recovery from the failure can be accelerated.

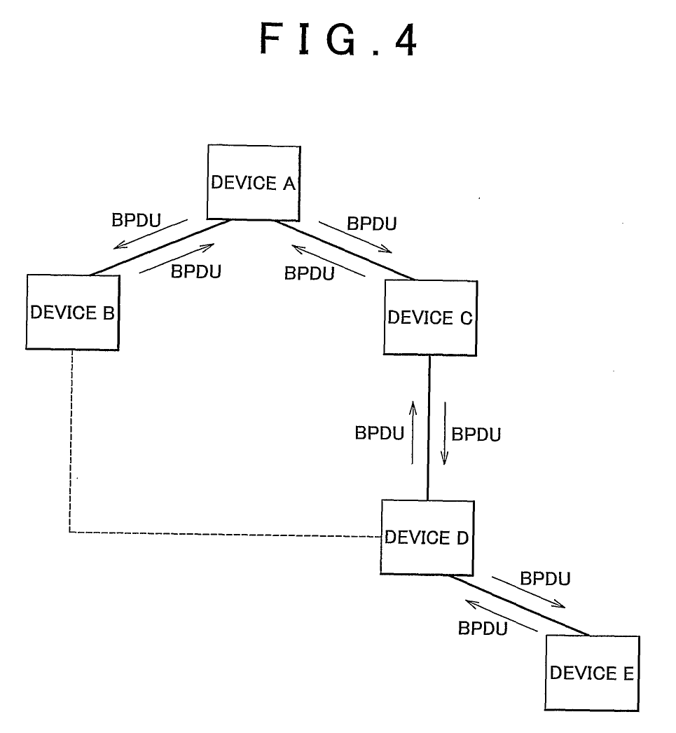

FIG. 4 is a schematic diagram of a network configured by the network device of the embodiment and employing the RSTP. As shown in FIG. 4, in the network configured by network devices A to E, a BPDU is periodically transmitted from network device A, which is a root. Furthermore, in the embodiment, a BPDU is also periodically transmitted from each network device to the network device positioned on the side of network device A, which is a root.

Thus, not only a BPDU is transmitted from the root, but a BPDU is also transmitted from each network device to the root. In other words, a network device that is neither a network root, nor a terminal network device, such as network device C or D, transfers a BPDU bidirectionally.

In the embodiment, the communication system may be a half duplex communication system or a full duplex communication system, and the full duplex communication system in which bidirectional BPDU transfer can be performed simultaneously is preferred from the standpoint of rapid recovery from a failure.

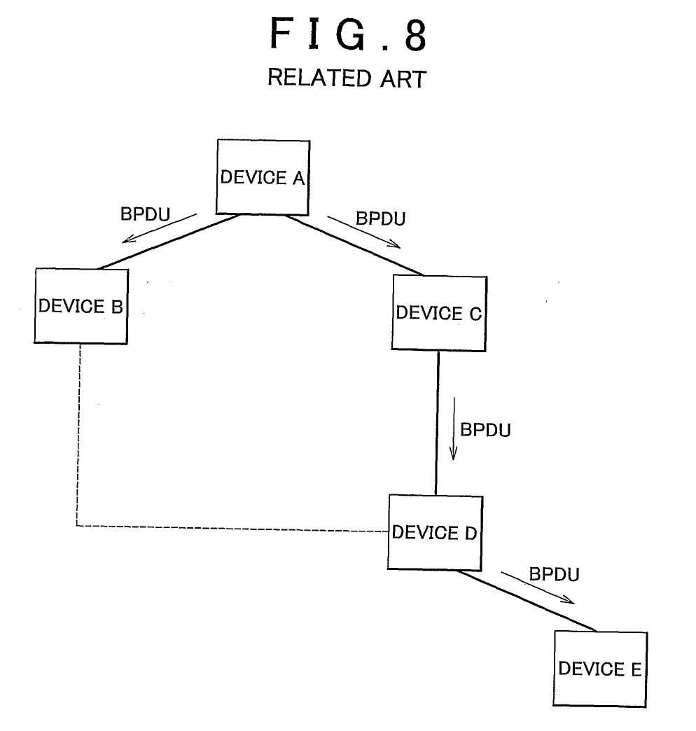

In a typical network shown in FIG. 8, a BPDU is transmitted only in one direction from the root. For example, when disconnection occurs between network device D and network device E, network device E can recognize the disconnection because the BPDU does not arrive within a predetermined period. However, because no redundant path is present, other network devices cannot determine that the disconnection has occurred. More specifically, when real time data are transferred from network device A to network device E, the data are stopped at network device D. The problem is that network device A cannot recognize this event.

In the network of the embodiment shown in FIG. 4, a BPDU is transferred bidirectionally as described hereinabove. For example, when a disconnection occurs between network device D and network device E, network device D can recognize the disconnection because the BPDU from network device E does not arrive within a predetermined period. Furthermore, other network devices can be rapidly notified about the disconnection.

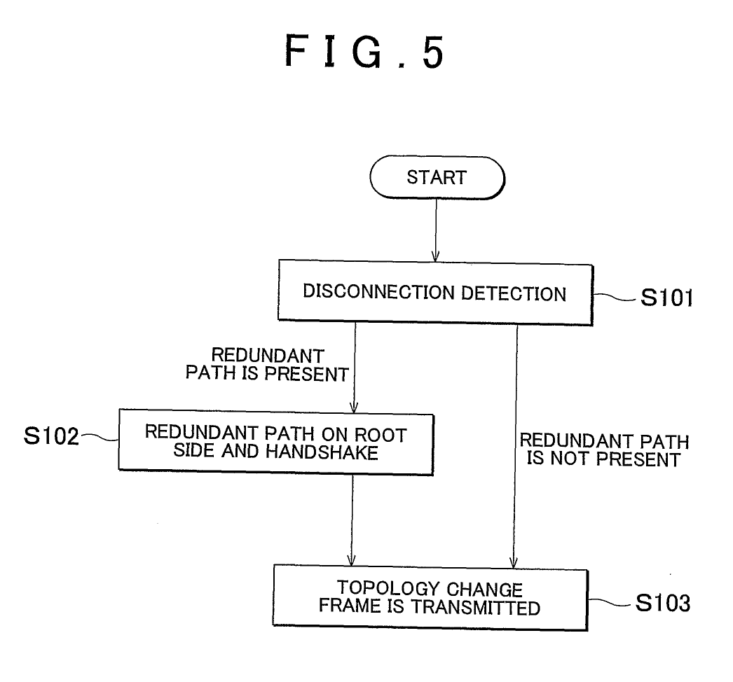

In the network of the embodiment, the restoration operation from the failure is started according to the flowchart shown in FIG. 5. More specifically, for example, when a disconnection occurs between network device C and network device D, a BPDU from network device C does not reach network device D. Furthermore, a BPDU from network device D does not reach network device C. As a result, network disconnection is detected (S101).

When a redundant path is present in the network, network device D then starts a handshake with network device B via the redundant path on the side of the root shown by a broken line in FIG. 4 (S102). Network device B and network device D are physically connected, but the connection therebetween was blocked in order to avoid an endless loop of a frame. In response to a request from network device D, network device B activates the network connection between the two network devices. Thus, a new topology is created in the network.

A frame indicating the topology change is sent from network device D and transmitted to all the devices (S103). Thus, when a redundant path is present in a network, the device that has detected a disconnection performs a handshake via the redundant path in the same manner as in the typical network shown in FIG. 8.

For example, when a disconnection occurs between network device D and network device E in the network shown in FIG. 4, a BPDU from network device D does not reach network device E. Furthermore, a BPDU from network device E does not reach network device D. As a result, network disconnection is detected (S101).

Because no redundant path is present between network device E and the other network devices, the frame demonstrating a topology change is transmitted from network device D and transferred to all the device, without performing operations of S102 (S103).

As explained hereinabove, in the embodiment, a BPDU is arranged and transferred in a reserved transfer interval of each cycle. As a result, a BPDU can be reliably transferred in each cycle. Therefore, a failure can be instantaneously detected and recovery from the failure can be accelerated. Furthermore, a cycle end interval E is provided in the final section of the free transfer interval. As a result, a BPDU can be more reliably transferred in each cycle.

As explained hereinabove, after a BPDU has been received from another network device, a BPDU created correspondingly to the status of the own device or the like is transmitted to another network device, but such a configuration is not limiting. For example, a BPDU may be transmitted between two network devices from among the network devices shown in FIG. 4. More specifically, a BPDU may be transferred in the same manner between the device A and the device C, between the device A and the device B, between the device C and the device D, and between the device D and the device E.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A network device that transfers frames by repeating, in a constant cycle, a reserved transfer interval that is a time band, in which a frame is transferred with a reservation, and a free transfer interval that is a time band, in which a frame is freely transferred, comprising:
a BPDU generation unit that generates a first BPDU; and
a BPDU transmission instruction unit that instructs to arrange the first BPDU in the reserved transfer interval and transmit the first BPDU to a first other network device.

2. The network device according to claim 1, wherein:
a synchronization frame for synchronizing network devices within a network is arranged in a header of the reserved transfer interval; and
the first BPDU is arranged to follow the synchronization frame.

3. The network device according to claim 1, further comprising a BPDU reception unit that receives a second BPDU transmitted from a second other network device,
wherein the BPDU generation unit generates the first BPDU on the basis of the second BPDU.

4. The network device according to claim 3, wherein:
the BPDU reception unit receives a third BPDU transmitted from the first other network device;
the BPDU generation unit generates a fourth BPDU on the basis of the third BPDU; and
the BPDU transmission instruction unit arranges the fourth BPDU in the reserved transfer interval and transmits the fourth BPDU to the second other network device.

5. The network device according to claim 1, wherein an interval in which a frame transfer is prohibited is provided at an end of the free transfer interval.

6. The network device according to claim 1, wherein a frame gap is provided at least in one of before and after each of the BPDU.

7. The network device according to claim 4, wherein a system of communication between the first and second other network devices is a full duplex system.

8. The network device according to claim 7, wherein:
one of the first other network device and the second other network device receives a fifth BPDU transmitted from a third other network device connected to one of the first other network device and the second other network device;
the third other network device is not directly connected to the network device; and
when the third other network device and one of the first other network device and the second other network device are disconnected, one of the first other network device and the second other network device notifies the network device about the disconnection.

9. The network device according to claim 3, wherein:
when the connection between the network device and either of the first other network device and the second other network device is disconnected and a redundant path exists between the one of the other network device that has been disconnected and the network device or the other one of the other network device, the one of the other network device activates the redundant path; and
the one of the other network device transmits a fifth BPDU to the network device or the other one of the other network device connected by the redundant path.

10. A network system comprising:
a network device that transfers frames by repeating, in a constant cycle, a reserved transfer interval that is a time band, in which a frame is transferred with a reservation, and a free transfer interval that is a time band, in which a frame is freely transferred,
wherein the network device generates a first BPDU, arranges the first BPDU in the reserved transfer interval, and transmits the first BPDU to a first other network device.

11. The network system according to claim 10, wherein:
a synchronization frame for synchronizing network devices within a network is arranged in a header of the reserved transfer interval; and
the first BPDU is arranged to follow the synchronization frame.

12. The network system according to claim 10, wherein:
the network device further comprises a BPDU reception unit that receives a second BPDU transmitted from a second other network device; and
the BPDU generation unit generates the first BPDU on the basis of the second BPDU.

13. The network system according to claim 12, wherein the network device receives a third BPDU transmitted from the first other network device, generates a fourth BPDU on the basis of the third BPDU, arranges the fourth BPDU in the reserved transfer interval, and transmits the fourth BPDU to the second other network device.

14. The network system according to claim 10, wherein an interval in which a frame transfer is prohibited is provided at an end of the free transfer interval.

15. The network system according to claim 10, wherein a frame gap is provided at least in one of before and after each of the BPDU.

16. The network system according to claim 13, wherein a system of communication between the first and second other network devices is a full duplex system.

17. The network system according to claim 16, further comprising a third other network device connected to one of the first other network device and the second other network device,
wherein the third other network device is not directly connected to the network device,
wherein when the third other network device and one of the first other network device and the second other network device are disconnected, one of the first other network device and the second other network device notifies the network device about the disconnection.

18. The network system according to claim 12, wherein:
when the connection between the network device and one of the first other network device and the second other network device is disconnected and a redundant path exists between the one of the other network device that has been disconnected and the network device or the other one of the other network device, the one of the other network device activates the redundant path; and
the one of the other network device transmits a fifth BPDU to the network device or the other one of the other network device connected by the redundant path.

19. A frame transfer method comprising:
transferring frames between network devices by repeating, in a constant cycle, a reserved transfer interval that is a time band, in which a frame is transferred with a reservation, and a free transfer interval that is a time band, in which a frame is freely transferred,
wherein a first network device generates a first BPDU, arranges the first BPDU in the reserved transfer interval, and transmits the first BPDU to a second network device.

20. The frame transfer method according to claim 19, wherein the first network device arranges a synchronization frame for synchronizing network devices within a network in a header of the reserved transfer interval and arranges the first BPDU to follow the synchronization frame.

21. The frame transfer method according to claim 19, wherein the first network device receives a second BPDU transmitted from a third network device and generates the first BPDU on the basis of the second BPDU.

22. The frame transfer method according to claim 21, wherein the first network device receives a third BPDU transmitted from the second network device, generates a fourth BPDU on the basis of the third BPDU, arranges the fourth BPDU in the reserved transfer interval, and transmits the fourth BPDU to the third network device.

23. The frame transfer method according to claim 19, wherein an interval in which frame transfer is prohibited is provided at an end of the free transfer interval.

24. The frame transfer method according to claim 22, wherein a system communication between the first network device and the second and third network devices is a full duplex system.

25. The network device according to claim 5, wherein:
when the connection between the network device and either of the first other network device and the second other network device is disconnected and a redundant path exists between the one of the other network device that has been disconnected and the network device or the other one of the other network device, the one of the other network device activates the redundant path; and
the one of the other network device transmits a fifth BPDU to the network device or the other one of the other network device connected by the redundant path.

26. The network device according to claim 6, wherein:
when the connection between the network device and either of the first other network device and the second other network device is disconnected and a redundant path exists between the one of the other network device that has been disconnected and the network device or the other one of the other network device, the one of the other network device activates the redundant path; and
the one of the other network device transmits a fifth BPDU to the network device or the other one of the other network device connected by the redundant path.

27. The network system according to claim 14, wherein:
when the connection between the network device and one of the first other network device and the second other network device is disconnected and a redundant path exists between the one of the other network device that has been disconnected and the network device or the other one of the other network device, the one of the other network device activates the redundant path; and
the one of the other network device transmits a fifth BPDU to the network device or the other one of the other network device connected by the redundant path.

28. The network system according to claim 15, wherein:
when the connection between the network device and one of the first other network device and the second other network device is disconnected and a redundant path exists between the one of the other network device that has been disconnected and the network device or the other one of the other network device, the one of the other network device activates the redundant path; and
the one of the other network device transmits a fifth BPDU to the network device or the other one of the other network device connected by the redundant path.
